(19) United States
(12) Patent Application Publication
(10) Pub. No.: US 2021/0405639 A1
(43) Pub. Date: Dec. 30, 2021

(54) Driver Assistance System for an Autonomously Driving Vehicle, and Method for Guiding an Autonomously Driving Vehicle

(71) Applicant: Bayerische Motoren Werke Aktiengesellschaft, Muenchen (DE)

(72) Inventors: Ronald ECKER, Muenchen (DE); Dennis LENZ, Muenchen (DE); Henri PALLEIS, Muenchen (DE); Dominik RIETH, Muenchen (DE); Roland WILHELM, Muenchen (DE)

(21) Appl. No.: 17/292,904

(22) PCT Filed: Nov. 22, 2019
(86) PCT No.: PCT/EP2019/082214

§ 371 Date: May 11, 2021

(30) Foreign Application Priority Data
Nov. 23, 2018 (DE) 10 2018 129 572.3

(51) Int. Cl. G05D 1/02; B60W 60/00

(52) U.S. Cl. CPC G05D 1/028; B60W 60/0013; B60W 60/00253; B60W 2554/802; B60W 2540/041; B60W 2554/4041; B60W 2554/801; G05D 2201/0213

(57) ABSTRACT

A driving assistance system for an autonomously driving vehicle includes environment sensors in the vehicle, which are configured to detect environment data of the vehicle; a computing unit, which is configured to determine the position of a target person in a surrounding area of the vehicle on the basis of the environment data; and a device for autonomous driving, which is configured to move the vehicle to a position which is located at a predetermined distance or less from the position of the target person and to stop the vehicle there.

### BACKGROUND AND SUMMARY OF THE INVENTION

The disclosure relates to a driving assistance system for an autonomously driven vehicle, a vehicle having such a driving assistance system, and a method for driving an autonomously driven vehicle. The present disclosure relates in particular to a targeted movement and stopping of the vehicle, in particular for picking up a passenger.

### PRIOR ART

Driving assistance systems for (partially) autonomously driven vehicles are steadily gaining in importance. Such driving assistance systems allow vehicles to drive and navigate with little or no user input. For example, autonomously driven vehicles can be used as taxis, which can pick up passengers and take them to their destination independently without a driver. In particular, for the purpose of picking up a passenger, the autonomously driven vehicle should be navigated to the passenger in a suitable and targeted manner in order not to cause any inconvenience to the passenger.

It is an object of the present disclosure to specify a driving assistance system for an autonomously driven vehicle, a vehicle having such a driving assistance system, and a method for guiding an autonomously driven vehicle, which enable improved convenience for the user. In particular, one of the objects of the present disclosure is to position an autonomously driven vehicle in the immediate vicinity of a target person.

This object is achieved by the claimed invention.

According to an independent aspect of the present disclosure, a driving assistance system for an autonomously driven vehicle is specified. The driving assistance system comprises an environment sensor system in the vehicle configured to collect environment data of the vehicle, a computing unit configured to determine a position of a target person in a surrounding area of the vehicle based on the environment data, and an autonomous driving device configured to move the vehicle to, and stop it at, a position that is located at a predetermined distance or less from the position of the target person.

According to some embodiments of the invention, a target person is localized by the environment sensor system of the vehicle and the vehicle is automatically driven to the target person and brought to a stop there. The target person in this case is a person who intends to enter the vehicle. For example, the target person is a passenger to be picked up at a specific location. The vehicle can drive autonomously, i.e. without a driver, to the target person's location and pick up the target person there. The environment sensor system allows an exact localization of the target person that goes beyond a simple GPS localization, so that the target person does not first have to walk a few steps to enter the vehicle. For example, the vehicle can be positioned in such a way that a door of the vehicle is positioned directly next to the target person, so that the target person can enter the vehicle directly. For example, the door can be an electric door that opens automatically.

The environment sensor system is an active sensor system of the vehicle having one or more sensors. In other words, some embodiments of the invention do not use passive means, such as GPS data on the person, to move the vehicle to the target person and stop there at the end of the navigation to the destination.

Preferably, the environment sensor system comprises at least one LiDAR system, at least one radar system, at least one camera, at least one ultrasound system, and/or a system for localizing mobile external devices. The environment sensor system can be integrated or installed in the vehicle. In some embodiments, the environment sensor system already present in the vehicle can be used to locate the target person and to drive the vehicle to the exact position of the target position and to park there. This typically means that no hardware modifications to the vehicle are necessary in order to implement the object according to the invention.

Preferably, the system for localizing mobile external devices is configured to determine a position of a mobile identification transmitter in the area surrounding the vehicle. The mobile identification transmitter may be in the direct possession of the target person. The position of the mobile identification transmitter can be determined, for example, by using Bluetooth and/or Ultra Wide Band (UWB). The computing unit can be configured to determine the position of the person based additionally on the determined position of the mobile identification transmitter.

For example, the system for localizing mobile external devices can be used for the localization if the remaining distance between the vehicle and the target person is greater than a threshold value. If the remaining distance between the vehicle and the target person is less than (or equal to) the threshold value, another environment sensor system can be used, such as the LiDAR system, the radar system, the camera, and/or the ultrasound system. For example, the threshold value can be in the range of 20 m to 5 m or 10 m to 5 m. In some embodiments, the sensor system of the vehicle can be used in combination with key radio technology for the precise localization of the target person to be picked up.

Preferably, the mobile identification transmitter is integrated in a key unit of the vehicle. Alternatively, the mobile identification transmitter is contained in a mobile terminal device. The term mobile terminal device includes, in particular, smartphones, but also other mobile telephones or cell phones, personal digital assistants (PDAs), tablet PCs as well as all current and future electronic devices, which are equipped, for example, with a key technology for vehicles.

Preferably, the type of localization of the target person is based on a current distance between the vehicle and the target person. For example, a first type of localization can be used in a first distance range, a second type of localization can be used in a second distance range, and optionally, a third type of localization can be used in a third distance range.

For example, the first type of localization can be carried out via Bluetooth. For example, the system for localizing mobile external devices can be used to locate a mobile terminal device of the target person via Bluetooth. The second type of localization can be carried out, for example, using an Ultra Wide Band (UWB) technology. For example, the system for localizing mobile external devices can be used to localize a mobile identification transmitter, which may be integrated in the mobile terminal device of the target person. The third type of localization can be carried out, for example, by using another near-range environment sensor system of the vehicle, such as a LiDAR system, a radar system, a camera, and/or an ultrasonic system.

Preferably, the first localization type (e.g. Bluetooth) is used with a remaining distance between the vehicle and the target person of <100 m. In addition or alternatively, the second localization type (e.g. UWB) is used with a remaining distance between the vehicle and the target person of <50 m and in particular, <30 m. In addition or alternatively, the third type of localization (e.g. the FAV sensor system) is used with a remaining distance between the vehicle and the target person in the near range, such as <10 m.

The first distance range can be between 100 m and 50 m (or 100 m and 30 m). The second distance range can be a range between 50 m (or 30 m) and 10 m. The third distance range can be a range between 10 m and 0 m. In particular, the third distance range can be a region directly surrounding the vehicle. However, the present disclosure is not limited to this, and the distance ranges or their sizes can be suitably chosen to make optimum use of the capabilities of the respective sensor system used for the localization.

In some embodiments, the first type of localization, the second type of localization, and/or the third type of localization are used consecutively in time, as described above. In other embodiments, the first type of localization, the second type of localization, and/or the third type of localization are used in combination (i.e. all at once or simultaneously). In particular, one, two or three types of localization can be used in the first distance range. In addition or alternatively, one, two or three types of localization can be used in the second distance range. In addition or alternatively, one, two or three types of localization can be used in the third distance range.

For example, the first localization type (e.g. Bluetooth) and the third localization type (e.g. radar and/or LiDAR) can be used in combination in at least one of the distance ranges (e.g. in the first, second, and/or third distance ranges). This can be the case, for example, because radar and/or LiDAR can have ranges of 200 m or more. In the third distance range, i.e. the near range around the vehicle, the authentication, e.g. using UWB, can be used for localization alone or in addition to the first type and/or third type. This is particularly advantageous when the user is to be authenticated, for example, to unlock the vehicle, such as to open the vehicle doors. In the third distance range, in particular, all three types of localization can be used in combination.

The device for automated driving is configured to move the vehicle to a position that is a predetermined distance or less from the position of the target person. The predetermined distance can be, for example, two meters or less, or one meter or less. For example, the vehicle can be positioned in such a way that a door of the vehicle is positioned directly next to the target person, so that the target person can enter the vehicle directly.

Preferably, the device for automated driving is configured to drive the vehicle partially automatically or fully automatically. The term “autonomous driving” can be understood for the purposes of this document to mean driving with automated longitudinal or lateral guidance, or autonomous driving with automated longitudinal and lateral guidance. Autonomous driving can consist, for example, of driving for a long time on the freeway or time-limited driving during parking or maneuvering. The term “autonomous driving” covers automated driving with any degree of automation. Examples of levels of automation are an assisted, partially automated, highly automated or fully automated driving mode. These levels of automation have been defined by the German Federal Highway Research Institute (BASt) (see the BASt publication “Forschung kompakt [Research digest]”, issue November 2012).

During assisted driving, the driver performs the longitudinal or lateral guidance all the time, while the system performs the other functions within certain limits. In partially automated driving (ex. TAF), the system takes control of the longitudinal and lateral guidance for a certain period of time and/or in specific situations while the driver has to constantly monitor the system, as in assisted driving. In highly automated driving (ex. HAF), the system takes control of the longitudinal and lateral guidance for a certain period of time without the driver having to constantly monitor the system; however, the driver must be in a position to take control of the vehicle within a certain period of time. In fully automated driving (ex. VAF), the system can automatically handle the driving in all situations for a specific application; for this application a driver is no longer required.

The four automation levels listed above correspond to SAE levels 1 to 4 of the SAE J3016 standard (SAE—Society of Automotive Engineering). For example, highly automated driving (ex. HAF) complies with level 3 of the SAE J3016 standard. In addition, SAE J3016 also provides SAE level 5 as the highest automation level, which is not included in the BASt definition. SAE level 5 is equivalent to driverless driving, in which the system can automatically handle all situations in the same way as a human driver throughout the entire journey; a driver is generally no longer required.

According to a further aspect of the present disclosure, a vehicle is specified comprising the driving assistance system according to the embodiments of the present disclosure. The term “vehicle” includes cars, trucks, buses, motor homes, motorcycles, etc., which are used for transporting people, goods, etc. In particular, the term includes motor vehicles for passenger transport, such as taxis.

According to a further independent aspect of the present disclosure, a method for guiding an autonomously driven vehicle is specified. The method comprises collecting environment data by using an environment sensor system of the vehicle, determining a position of a target person in a surrounding area of the vehicle based on the environment data, and autonomously moving the vehicle to a position that is a predetermined distance or less from the position of the target person.

The method can be implemented by the driving assistance system of the present disclosure. In addition, the method may include or embody the aspects described in relation to the driving assistance system.

Exemplary embodiments of the disclosure are shown in the drawings and will be described in more detail in the following.

### BRIEF DESCRIPTION OF THE DRAWINGS

FIG. 1 shows a schematic view of a driving assistance system for an autonomously driven vehicle according to embodiments of the present disclosure.

FIG. 2 shows an operating principle of the driving assistance system according to embodiments of the present disclosure.

FIG. 3 shows different distance ranges for the distance-dependent localization of the target person according to embodiments of the present disclosure.

FIG. 4 shows a flowchart of a method for driving an autonomously driven vehicle according to embodiments of the present disclosure.

### DETAILED DESCRIPTION OF THE DRAWINGS

In the following, unless otherwise noted, the same reference signs are used for identical and equivalent elements.

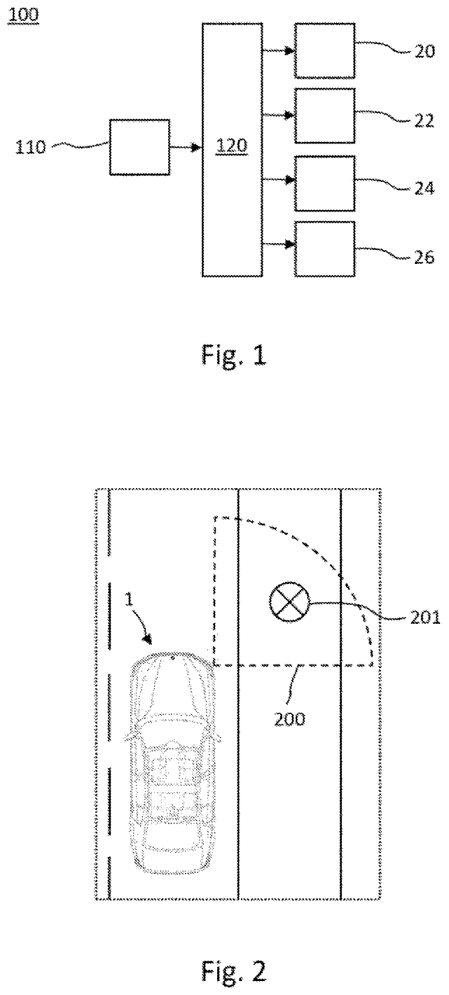

FIG. 1 shows a schematic view of a driving assistance system 100 for an autonomously driven vehicle according to embodiments of the present disclosure.

The driving assistance system 100 comprises an environment sensor system 110 which is configured to collect environment data, a computing unit 120 which is configured to determine a position of a target person in the surrounding area of the vehicle based on the environment data, and a device for automated driving which is configured to move the vehicle to a position that is located at a predetermined distance or less from the position of the target person. The environment data can specify an area surrounding the vehicle, or characteristics of the area surrounding the vehicle.

The device for automated driving is configured to drive the vehicle partially or fully automatically (autonomously). In such an automated driving mode, the longitudinal and lateral guidance of the vehicle are performed automatically. The driving assistance system 100 thus takes control of the vehicle guidance, for example until the vehicle is brought to a standstill next to the target person. For this purpose, the driving assistance system 100 controls the drive unit 20, the transmission 22, the (e.g. hydraulic) foot brake 24, and the steering 26 via intermediate units, not shown.

The environment sensor system 110 is configured to localize the target person in an area surrounding the vehicle. The localization can include, for example, direct localization and/or indirect localization of the target person.

The direct localization detects the target person directly, for example by use of a LiDAR system, a radar system, one or more cameras, and/or an ultrasound system. Indirect localization detects the person indirectly, for example, via a mobile identification transmitter or a mobile terminal device that is located with the target person and can be localized by the vehicle.

Typically, for indirect localization the system for localizing mobile external devices is used. The system for localizing mobile external devices can determine the position of the mobile identification transmitter or mobile terminal device, for example, using Bluetooth and/or Ultra Wide Band (UWB).

Preferably, the direct localization is used in combination with the indirect localization to steer the vehicle to the exact position of the passenger to be collected. In particular, the indirect localization with long range can be used in a larger distance range. In a near range, the direct localization using the near-range environment sensor system of the vehicle can be used.

FIG. 2 shows the operating principle of the driving assistance system according to embodiments of the present disclosure.

The device for automated driving is configured to move the vehicle 1 to a position that is a predetermined distance or less from the position 201 of the target person. The predetermined distance can be, for example, two meters or less, or one meter or less.

For example, the vehicle 1 can be positioned in such a way that a door of the vehicle is positioned directly next to the target person, so that the target person can enter the vehicle 1 directly without having to walk a few steps. In another example, the vehicle 1 can be positioned in such a way that the trunk of the vehicle 1 is positioned directly next to the target person, so that the target person can, for example, load luggage directly into the vehicle 1 without having to walk a few steps. For this purpose, for example, the target person can send a corresponding request to the vehicle 1 using his/her mobile terminal device, such as an app on his/her smartphone.

In some embodiments, the near-range environment sensor system of the vehicle 1 can be used to localize the person directly. The near-range environment sensor system can be configured to directly detect subjects and objects in a specific surrounding area 200 of the vehicle. The surrounding area 200 can be, in particular, a near range of the vehicle 1. For example, the near range can be defined by a distance or radius of 20 m or less, 10 m or less, or 5 m or less around the vehicle 1.

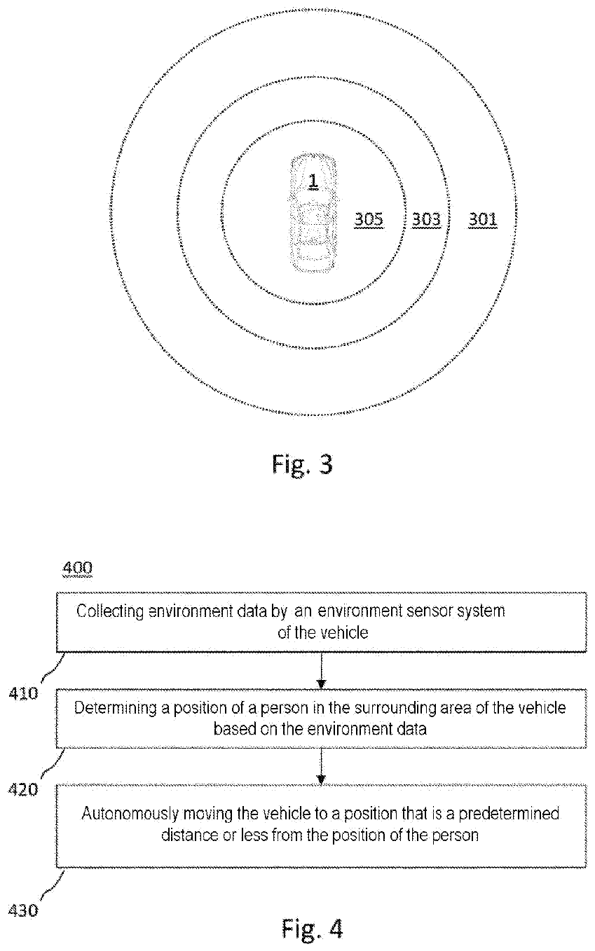

FIG. 3 shows different distance ranges around the vehicle 1 for the distance-dependent localization of the target person according to embodiments of the present disclosure.

According to the present disclosure, two or more types or techniques for localizing the target person may be used, sequentially and/or simultaneously, based on the distance between the vehicle 1 and the target person.

As illustrated in the example of FIG. 3, a first type of localization can be used in a first distance range (or surrounding area) 301, a second type of localization can be used in a second distance range (or surrounding area) 303, and optionally a third type of localization can be used in a third distance range (or surrounding area) 305. The first distance range 301, the second distance range 303 and the third distance range 305 can be defined adjacent to each other around the vehicle. In particular, the third distance range 305 can be a region directly surrounding the vehicle 1. The second distance range 303 can be arranged between the first distance range 301 and the third distance range 305.

Although FIG. 3 shows three distance ranges as an example, the present disclosure is not limited to these. In particular, there may be two or more than three distance ranges present, in which respective sensors are used to localize the target person.

In some embodiments, the first distance range 301 can be a range between 100 m and 50 m (or 100 m and 30 m) around the vehicle 1. The second distance range 303 can be a range between 50 m (or 30 m) and 10 m around the vehicle 1. The third distance range 305 can be a range between 10 m and 0 m around the vehicle 1.

The first type of localization in the first distance range 301 can be performed using Bluetooth, for example. For example, the system for localizing mobile external devices of the environment sensor system can be used to locate a mobile terminal device of the target person using Bluetooth.

The second type of localization in the second distance range 303 can be implemented, for example, using an Ultra Wide Band (UWB) technology. For example, the system for localizing mobile external devices can be used to localize a mobile identification transmitter, which may be integrated in the mobile terminal device of the target person, for example, or may be in the form of a radio key.

The third type of localization in the third distance range 305 can be carried out, for example, by the near-range environment sensor system of the vehicle 1, using e.g. a LiDAR system, a radar system, a camera, and/or an ultrasonic system.

Typically, a mobile external device of the target person is localized outside the near range of the vehicle 1, for example outside the third distance range 305. The mobile external device can be, for example, the mobile identification transmitter. The mobile identification transmitter can be designed as a separate unit (e.g. as a radio key), or can be integrated into a mobile terminal device belonging to the target person. The mobile terminal device may be, in particular, a smartphone.

Therefore, a plurality of localization techniques can be used successively and/or simultaneously to determine the position of the target person and to bring the vehicle to a stop directly in front of the target person. For example, the vehicle can be positioned in such a way that a door of the vehicle is directly in front of the target person.

FIG. 4 shows a flowchart of a method 400 for guiding an autonomously driven vehicle according to embodiments of the present disclosure.

The method comprises in block 410 collecting environment data by an environment sensor system of the vehicle, in block 420 determining a position of a target person in the surrounding area of the vehicle based on the environment data, and in block 430 automatically moving the vehicle to a position that is a predetermined distance or less from the determined position of the target person.

According to embodiments of the invention, a target person is localized by the environment sensors of the vehicle and the vehicle is automatically driven to the target person and brought to a stop there. The target person in this case is a person who intends to enter the vehicle. For example, the target person is a passenger to be picked up at a specific location. The vehicle can drive autonomously, i.e. without a driver, to the target person's location and pick up the target person there. The environment sensors allow an exact localization of the target person that goes beyond a simple GPS localization, so that the target person does not first have to walk a few steps to enter the vehicle. For example, the vehicle can be positioned in such a way that a door of the vehicle is positioned directly next to the target person, so that the target person can enter the vehicle directly.

1.-10. (canceled)

11. A driving assistance system for an autonomously driven vehicle, the driving assistance system comprising:
an environment sensor system which is configured to collect environment data of the vehicle;
a computing unit which is configured to determine a position of a target person in a surrounding area of the vehicle based on the environment data; and
a device for automated driving, which is designed to move the vehicle to a position that is a predetermined distance or less from the position of the target person.

12. The driving assistance system according to claim 11, wherein the environment sensor system is selected from the group consisting of the following:
at least one LiDAR system;
at least one radar system;
at least one camera; and
at least one ultrasound system.

13. The driving assistance system according to claim 11, further comprising a system for localizing mobile external devices, which is configured to determine a position of a mobile identification transmitter in the surrounding area of the vehicle.

14. The driving assistance system according to claim 13, wherein the computing unit is configured to determine the position of the target person based on the environment data and the determined position of the mobile identification transmitter.

15. The driving assistance system according to claim 13, wherein the mobile identification transmitter is integrated in a key unit of the vehicle, or wherein the mobile identification transmitter is contained in a mobile terminal device.

16. The driving assistance system according to claim 15, wherein the mobile terminal device is a smartphone.

17. The driving assistance system according to claim 11, wherein the predetermined distance is two meters or less.

18. The driving assistance system according to claim 17, wherein the predetermined distance is one meter or less.

19. The driving assistance system according to claim 11, wherein the device for automated driving is configured to guide the vehicle partially automatically or fully automatically.

20. A vehicle comprising a driving assistance system comprising:
an environment sensor system which is configured to collect environment data of the vehicle;
a computing unit which is configured to determine a position of a target person in a surrounding area of the vehicle based on the environment data; and
a device for automated driving, which is designed to move the vehicle to a position that is a predetermined distance or less from the position of the target person.

21. The vehicle according to claim 20, wherein the vehicle is a motor vehicle.

22. A method for guiding an autonomously driven vehicle, the method comprising:
collecting environment data of the vehicle by an environment sensor system of the vehicle;
determining a position of a target person in a surrounding area of the vehicle based on the environment data; and
autonomously moving the vehicle to a position that is a predetermined distance or less from the position of the target person.
